(19) United States
(12) Patent Application Publication
(10) Pub. No.: US 2016/0017640 A1
(43) Pub. Date: Jan. 21, 2016

(54) Electronic Door Locking System

(71) Applicant: Alarm Lock Systems, Inc., Amityville, NY (US)

(72) Inventors: Richard L. Soloway, Amityville, NY (US); Jorge D. Hevia, Amityville, NY (US); Charles S. Buccola, Amityville, NY (US)

(21) Appl. No.: 14/332,026

(22) Filed: Jul. 15, 2014

(51) Int. Cl. E05B 47/00; G07C 9/00

(52) U.S. Cl. CPC E05B 47/0012; G07C 9/00309; G07C 2009/00769; E05B 2047/005

(57) ABSTRACT

A door and locking assembly is disclosed for the electronic control of a door. The assembly includes a door having an exterior side, an interior side, a latch edge and an interior portion. An electronic control unit is provided. The control unit is located inside the door and is in communication with an antenna that is located on the external latch edge of the door. The control unit may be located in housing designed to fit within a mortised pocket in the door and the antenna may be protected by a cover that resembles a faceplate.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Field of the Invention

The present invention concerns electronic door-locking systems that are often used in commercial, office, educational, multi-dwelling apartment and even residential settings in which wireless communications are used to control the local operation of the door as well as networking control. Current locking systems often deploy a number of components such as a deadbolt, an electronically controlled door latch, a surface-mounted access control authentication device and a surface-mounted control unit having an antenna that permits wireless communications.

The access control authentication device is surface mounted on the exterior facing door surface for several reasons. First, the location allows the device to be accessed by a user. Second, surface mounting is required since doors are often made from materials that block or interfere with wireless and other signals, such as steel. This typically prevents the access control device from being located in the interior of the door.

The control unit is often located on the interior facing door surface so as to prevent tampering. In addition, to the extent the control unit uses an antenna for wireless local and wide area network communications, it too, cannot be mounted in the interior of the door for the reasons stated above.

Yet, surface mounting of the control unit and/or access control device is undesirable for several reasons. First, it mars the aesthetics of the door. Second, it leaves the devices exposed to tampering. Also, it leaves the devices exposed to potential damage or vandalism that may render the door inoperable.

Thus, there is a need to provide a locking system that maintains the aesthetics of a door while maintaining the operability and integrity of the system components. In addition, there is a need to achieve these benefits in a manner that still permits wireless communications so as to allow for the localized operation of the door and overall networking of the door locking system.

### BRIEF SUMMARY OF THE INVENTION

The present invention provides solutions to the above noted drawbacks of conventionally used door locking systems. In one embodiment described below, the invention provides, among other things, an assembly that comprises a control unit having an antenna that is mounted near the latch edge of a door. This arrangement maintains the aesthetics of the door while still providing remote wireless communications free from interference while maintaining system operability and resistance to damage, vandalism and tampering.

### BRIEF DESCRIPTION OF THE SEVERAL VIEWS OF THE DRAWINGS

FIG. 1 is a partial perspective view of an embodiment of the present invention with portions of the door removed for clarity.

FIG. 2 is a perspective view of a control unit of one embodiment of the invention.

FIG. 3 is a perspective view ala surface mountable external antenna.

FIG. 4 is a side view of the embodiment shown in FIG. 2.

FIG. 5 is a perspective view of the embodiment shown in FIG. 2 with portions removed to reveal the interior components.

FIG. 6 is a perspective view of an embodiment installed in a door jam.

### DETAILED DESCRIPTION OF THE INVENTION

This description is not to be taken in a limiting sense, but is made merely for the purpose of illustrating h general principles of the invention. The scope of the invention is defined by the appended claims.

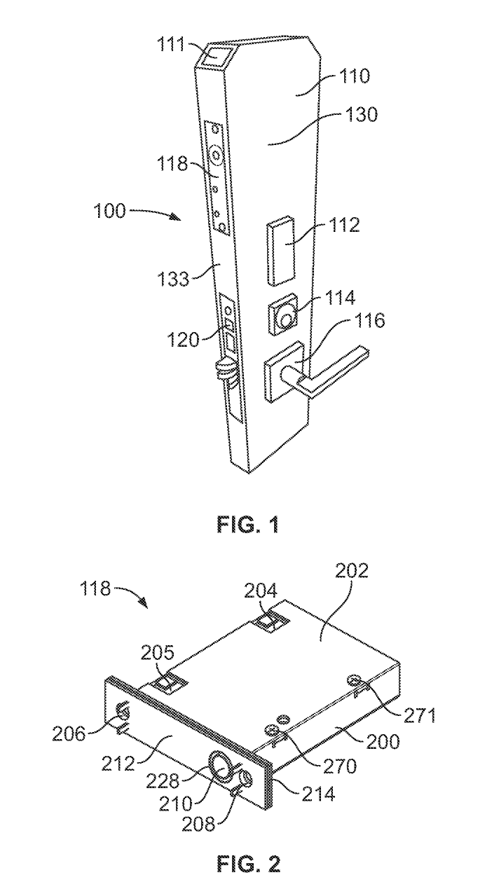

As shown in FIG. 1, in one embodiment, the present invention provides a door locking assembly 100 that includes a door 110, an access control authentication device 112, a turn piece 114, a door handle with a rose or cover 116, a control unit 118 and electronically controlled lock 120. Control unit 118 in combination with an antenna, in addition to other functions, may serve as both a transmitter and receiver of local and wide area network communications. Door 110 may be a composite made of wood, steel and other materials known to those of skill in the art and include an interior portion 111. Door 110 also has an exterior side 130, an interior side (not shown) and a latch edge 133.

Turn piece 114, door handle 116 and lock 120 are made in accordance with well-known techniques known to those of skill in the art. In one embodiment, device 112 is located on exterior 130 of door 110. Device 112 may be a magnetic swipe card, a proximity reader, a smart card, a PIV device, a keyfob, a remote RF device, a smart phone, biometric access reader, and other devices used to verify the authenticity of the user, the design and construction of which are known to those of skill in the art.

In one preferred embodiment, control unit 118 is located in a housing 200 (FIG. 2) that may be configured to fit into a mortise pocket made in door 110. In this configuration, door 110 includes two mortise pockets, the conventional one for lock 120 and another for control unit 118. While a mortised opening is preferred, other embodiments that may be used include locating control unit 118 in any sized or shaped portion, opening, space, or pocket in the door that holds the control unit in a secured manner.

As further shown in FIG. 2, in one embodiment, the present invention may also include a first faceplate 212 overlaying a second faceplate 214. Plates 212 and 214 are configured, in one embodiment, to serve as a two-piece faceplate that forms a flush fit with latch edge 133 of door 110. In another embodiment, the plates may be a single unit. Apertures 206 and 208 allow for the use of fasteners (such as screws) to affix the assembly to door 110.

As shown in FIGS. 2 through 4, aperture 228 may also provide a passageway 230 for electro-mechanical button 210 that may function as a switch. Button 210 may be used as a switch to perform a desired operation such as changing an operational mode of the device. Switch 210 may also used to change a programmed function of the device such as the addition of another user. Another function that may be performed by switch 210 is to disable the lock and maintain the lock in an unlocked state.

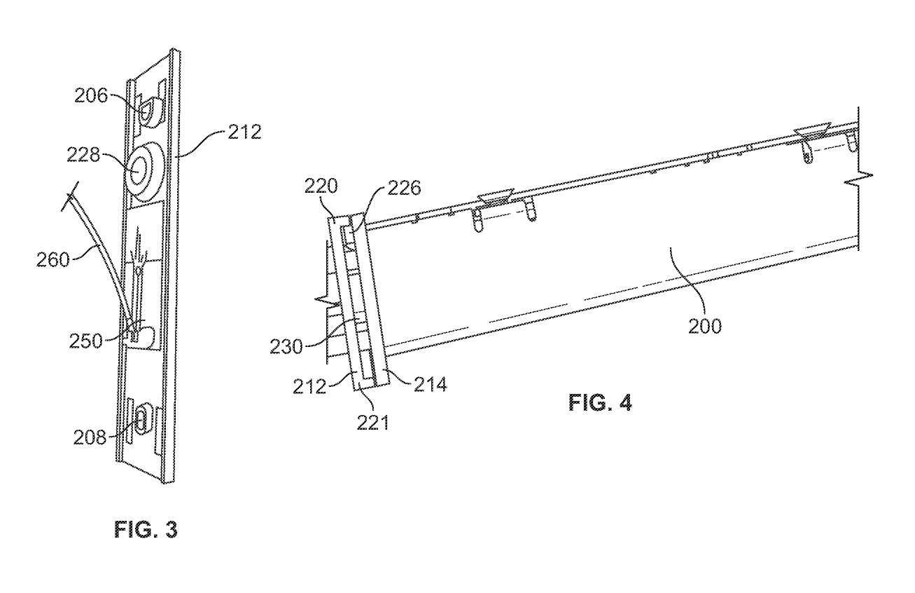

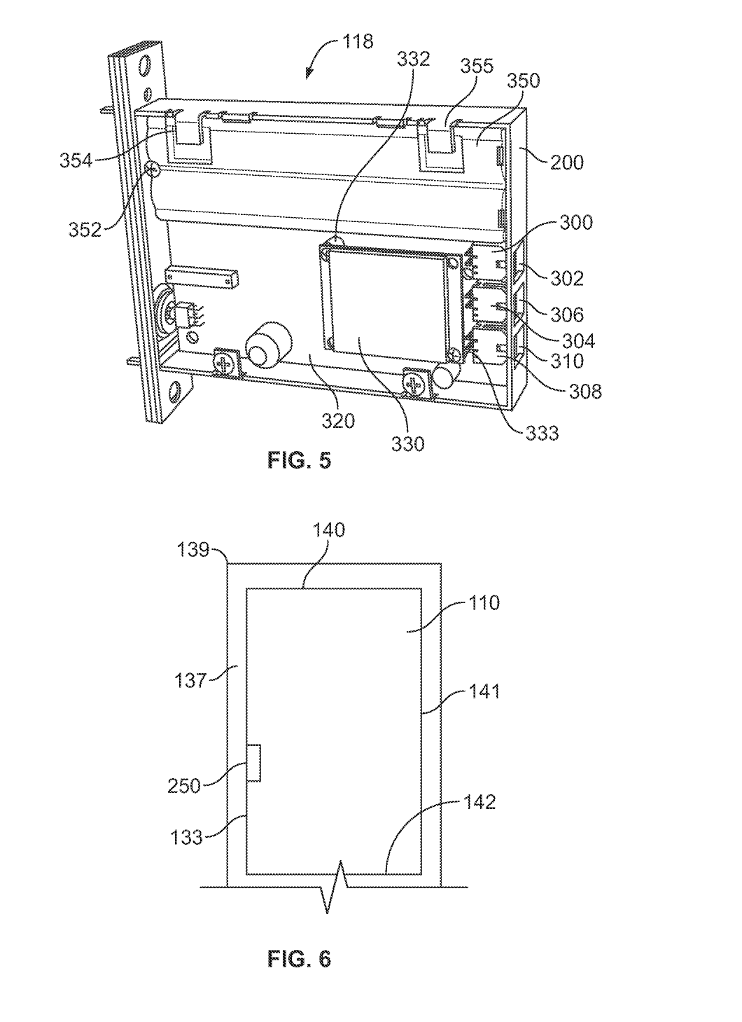

As shown in FIGS. 3 and 4, plates 212 and 214 are arranged to form a protective cover for antenna 250 and further configured to form an interior section or enclosure 226 that houses antenna 250. Wiring 260 connects antenna 250 to control unit 118. In addition, antenna 250 may communicate wirelessly with control unit 118. In a preferred embodiment, as shown in FIGS. 3 and 4, plate 212 includes legs 220 and 221, which permits the plates to be arranged in a spaced-apart relationship to form interior space 226. Alternately, the legs may be located on plate 214.

In an alternate embodiment, a single plate may be used as a cover for antenna 250 as well. In addition, while a plate in the style of a faceplate is described, other cover arrangements may be used as well to affix the antenna to the latch edge of the door in a recessed relationship.

In addition, the cover for the antenna, which may be one or more faceplates, may be combined with control unit 118 to form a single unit. Thus, the control unit, protective cover, and antenna may be comprised of separate components or may he combined together into a single unit. Lastly, the section of the assembly that overlays the antenna is preferably made of a material that will not interfere with the operation of the antenna. One suitable material is plastic.

Antenna 250 may also be located in control unit 118 thereby eliminating the need to use of one or more faceplates or other protective covers. For this embodiment, the portion of the control unit that houses the antenna is preferably made of a material that will not interfere with the operation of the antenna. hi addition, a preferred, but not required location, for this embodiment is to locate the control unit and antenna assembly near the edge of the door and more preferably near the latch edge of the door. However, the control unit and antenna assembly may be located at or near other edges as well as other locations in door 110.

In yet another preferred embodiment, antenna 250 is located a spaced distance away from control unit 118 and may be wired to the control unit or in wireless communication with the control unit. This improves RF performance and provides several advantages. First, it reduces or eliminates interference with wireless and electric signals. In addition, it eliminates the need to mount antenna 250 in a position that mars the aesthetics of the door. Lastly, it locates the antenna in a position, which reduces the potential for tampering and inadvertent damage. This arrangement permits the control electronics to be located in the interior of the door while still maintaining wireless communications, such as local and wide area network communications.

In yet a further embodiment, antenna 250 is located a spaced distance away from control unit 118 on the surface of the door. In this embodiment, the antenna is integrally formed with the surface or skin of the door. In another embodiment, the antenna is configured to create a profile that is substantially flush with the door surface and may be blended or matched with the door surface so as to be invisible, or relatively not noticeable, on the door. Antenna 250 may be planar in design with a low profile that blends in with the surface when painted or covered with some other skin known to those of skill in the art. Antenna 250 may also be located in a pocket on the door surface. Lastly, antenna 250 may be printed on the door surface.

A preferred location for antenna 250 is on latch edge 133 of door 110 as shown in FIG. 6. This location takes advantage of gap 137 between door 110 and door jam 139 so as to allow RF to emanate from antenna 250. Other suitable locations that take advantage of the space between door 110 and door jam 139 may also be used. These locations include hinge edge 140 of the door as well as the top edge 141 and bottom edge 142 of the door.

Antenna 250 may also be located in a spaced apart relationship from control unit 118 by mounting the antenna in other locations other than on an edge of the door. Other suitable locations include the interior of door 110, on the surface of door 110 or in a recess formed in the outer surface of door 110.

As shown in FIG. 2, housing 200 includes a cover 202 that is affixed to housing 200, which may be made of metal or plastic, by fasteners 270 and 271. Removal of cover 202 permits access to the electrical components of control unit 118. As shown, a battery pack 350 is provided which is affixed to housing 200 by one or more fasteners 352. In addition, retaining tabs 354 and 355 may also he provided to securely retain the battery within the housing. Deploying additional retention eliminates the pack from moving during use thereby eliminating potential damage and noise. Apertures 205 and 206 in cover 202 prevent interference with tabs 354 and 355.

Battery pack 350 may be accessed, by removing unit 118 from door 110. Alternately, battery pack 350 may also be accessed by the removal of plate 212 or by the removal of plates 212 and 214.

Housing 200 may also contain other electronics such as circuit board 320 and processor 330, which is mounted on posts 332 and 333. Electrical connectors 300, 304 and 308 may also be provided for connecting control unit 118 to access device 112, lock 120 and other components. The connectors are accessed via apertures 302, 306 and 310.

In yet another embodiment of the invention, antenna 250 may perform multiple functions. It may serve as a wireless antenna for receiving and sending network related signals. The network signals may be directed to and received from an intermediary transmitter and or transceiver such as a gateway or may be directed to and received from a server. In addition, antenna 250 or, a second antenna, may also serve as the antenna for an access control authentication device 112 that may be part of control unit 118 or another control unit located inside door 110. As set forth above, this embodiment further reduces the components located on the external surface of the door and achieves the advantages stated above.

In yet other embodiments of the invention, access control authentication device 112 may be located in a number of locations that enhance the aesthetics of the door without impairing or sacrificing operability. For example, device 112 may be located on or near the latch edge of the door. It may also use a protective cover in a manner as was described above for antenna 250. In a preferred embodiment, device 112 is located in a protective cover, which may also include antenna 250, located on the latch edge of the door.

Device 112 may also be located in the control unit 118 in any of the locations described above discussing the location and placement of control unit 118. In addition, device 112 may be located a spaced distance from the control unit in the interior of the door or in a recess located on the surface of the door.

Device 112 may also be located inside rose 116. In addition, for yet another embodiment, device 112 may also be located on or in jam 139, on or in a wall near the door or other structure surrounding the door so as to not be part of the door.

Device 112, for the embodiments described, may be hardwired to control unit 118. In addition, device 112 may be in wireless communication with control unit 118.

in use, to enable local and network communications for a preferred embodiment of the present invention, a door is first installed within a door jam by mounting it therein so as to produce a gap between the door and door jam. An antenna is positioned in a location, such as on the latch edge of the door, so as to enable RF to emanate from the gap between the door and door jam. In addition, an access control authentication device may also be provided. The access control authentication device is also positioned to permit electronic signals to emanate from the gap between the door and door jam. Both the antenna and access control authentication device are in communication with a control unit located within the door that controls the operation of the door.

What is claimed is:

1. A door and locking assembly comprising:
a door having an exterior side, an interior side, and a latch edge;
an electronic control unit located inside said door;
an antenna located on said latch edge of said door; and
said antenna in communication with said control unit.

2. The assembly of claim 1 wherein said antenna enables wireless network communications.

3. The assembly of claim 1 wherein said antenna enables the control unit to function as an access control device.

4. The assembly of claim 1 wherein said antenna is protected by a cover.

5. The assembly of claim 4 wherein said cover is configured as a faceplate.

6. The assembly of claim 5 wherein said faceplate is comprised of a first plate and a second plate, said plates spaced apart to form an interior space in which said antenna is located.

7. The assembly of claim 1 wherein control unit is located in a housing, said housing adapted to fit inside an opening in said door.

8. The assembly of claim 7 wherein said opening is a mortise pocket.

9. The assembly of claim 1 further including an access control device, a dead bolt, a latch and a lock.

10. The assembly of claim 4 wherein said cover is removable from said door and, when removed, provides access to a battery pack.

11. The assembly of claim 7 wherein said housing is made of metal or plastic.

12. A door and locking assembly comprising:
a door having an exterior surface, an interior surface and a latch edge;
a first opening located in said door and adapted to receive a lock;
a second opening located in said door and adapted to receive a control unit that is in
electrical communication with said lock; and
an antenna in electrical communication with said control unit, said antenna located on said latch edge of said door.

13. The assembly of claim 12 wherein said antenna enables wireless network communications.

14. The assembly of claim 12 wherein said antenna enables the control unit to function as an access control device.

15. The assembly of claim 12 wherein said antenna is protected by a cover.

16. The assembly of claim 15 wherein said cover is configured as a faceplate.

17. The assembly of claim 16 wherein said faceplate is comprised of a first plate and a second plate, said plates spaced apart to form an interior space in which said antenna is located.

18. The assembly of claim 12 wherein said control unit is located in a housing, said housing sized to fit in said opening.

19. The assembly of claim 12 further including an access control authentication device, a deadbolt, a latch and a lock.

20. The assembly of claim 12 wherein said openings are mortise openings.

21. The assembly of dam 12 wherein said housing is made of metal or plastic.

22. An electronic control unit and antenna assembly for controlling the operation of a door comprising:
a housing adapted to enclose the control unit;
said housing adapted to be secured inside a door, and
an antenna enabling RF communications with said control unit.

23. The assembly of claim 22 wherein said housing is adapted to fit within a pocket in said door.

24. The assembly of claim 22 wherein said pocket is a mortise pocket.

25. The assembly of claim 22 wherein said antenna is located in said, housing.

26. The assembly of claim 22 wherein said antenna is located a spaced distance from said control unit and inside the door.

27. The assembly of claim 22 wherein said antenna is located a spaced distance from said control unit on an outer edge of the door.

28. The assembly of claim 22 wherein said antenna is located a spaced distance from said control unit on the latch edge of the door.

29. The assembly of claim 22 further including an access control device in communication with said control unit, said access control device located in said housing.

30. The assembly of claim 22 further including an access control device in communication with said control unit, said access control device located a spaced distance from said control unit and inside the door.

31. The assembly of claim 22 further including an access control device in communication with said control unit, said access control device located a spaced distance from said control unit on an outer edge of the door.

32. The assembly of claim 31 wherein said access control device is located a spaced distance from said control unit on the latch edge of the door.

33. The assembly of claim 29 wherein said housing includes a faceplate and said antenna is located within said faceplate.

34. The assembly of claim 33 wherein said access control device is located within said face plate.

35. The assembly of claim 34 wherein said antenna and said access control device are located within said faceplate, and said faceplate is located on the latch edge of the door.

36. The assembly of claim 22 wherein said housing is made of metal or plastic.

37. The assembly of claim 22 wherein said antenna is located on the surface of the door.

38. The assembly of claim 22 wherein said antenna is located in a pocket located on the surface of the door.

39. The assembly of claim 22 wherein said antenna is printed on the surface of the door.

40. A method of enabling RF communications between an antenna and a control unit for controlling the operation of a door adapted to fit within a door jam comprising the steps of:
mounting a door within the door jam to produce a gap between the door and door jam;
providing a control unit in the door, said control unit adapted to electronically control the operation of the door;
providing an antenna to enable RF communication with the control unit, said antenna located in a position to permit RF to emanate from the gap between the door and door jam.

41. The method of claim 40 further comprising the step of providing an access control authentication device that is in electronic communication with said control unit, said access control device positioned to permit electronic signals to emanate from said gap between the door and door jam.

42. The assembly of claim 19 wherein said access control authentication device is located in a rose on said door.

43. The assembly of claim 19 wherein said access control authentication device is not part of the door.
